(19) United States
(12) Patent Application Publication
(10) Pub. No.: US 2022/0279792 A1
(43) Pub. Date: Sep. 8, 2022

(54) Antimicrobial nanostructured silver perovskite oxides

(71) Applicant: Cyrus Talebpour, Richmond Hill (CA)

(72) Inventors: Cyrus Talebpour, Richmond Hill (CA); Houshang Alamdari, Quebec (CA); Hossein Salimnia, Rochester Hills, MI (US)

(21) Appl. No.: 17/177,202

(22) Filed: Feb. 17, 2021

Related U.S. Application Data
(60) Provisional application No. 62/977,411, filed on Feb. 17, 2020.

(51) Int. Cl. A01N 59/00

(52) U.S. Cl. CPC A01N 59/00

(57) ABSTRACT

The subject matter of the present invention is providing nanostructured silver perovskite oxides, which upon contact with microbial cells prevent their proliferation without releasing significant amounts of silver ions to the environment. These nanostructured oxides may be used as antimicrobial agents on exposed surfaces.

### FIELD OF THE INVENTION

This disclosure relates to compositions having antimicrobial properties and methods of their fabrication.

### BACKGROUND OF THE INVENTION

The misuse of antibiotics, which has led to the development of antimicrobial resistance (AMR), is a prevalent worldwide health issue. Thus, there is a need for countering AMR through strategies such as preventing the proliferation of microbial cells on surfaces of objects that somehow come into contact with disease causing pathogenic microbial cells in particular places, such as operating rooms or the intensive critical units of hospitals. Any remedy for rendering antimicrobial property to these vulnerable surfaces is desired to have the following characteristics: 1) Present no systemic toxicity to humans, 2) Do no have long/short term adverse environmental effects, 3) Present broad-spectrum antimicrobial activity, meaning that the proliferation of most species of microbial cells, in contrast to selected category of species, be prevented, 3) The surface be robust, meaning that it does not require special handling, 4) The approach for treating surfaces should involve low cost production procedures for delivering affordable surfaces.

To the best of our knowledge, the materials that can satisfy most of these requirements to some extent are silver compounds, which while having broad spectrum antimicrobial activity, are relatively safe for mammalian cells. However, the conventional silver, typically in the form of soluble silver salts or silver nanoparticles, is far from ideal for antimicrobial surface coating. Silver is an expensive metal and degrades while releasing ions to the ambient. These ions are the agents which impart the antimicrobial action. Unfortunately, the high levels of silver ions are a health and environmental hazard that must be avoided. The best-described adverse effect in humans of chronic exposure to silver is a permanent bluish-grey discoloration (argyria or argyrosis) of the skin or eyes. Accordingly, the established risk assessments are currently based on the development of argyria. In addition to health risk the environmental impact of the released silver ions cannot be underestimated. These ions may finally end up in lakes and affect the composition of bacterial flora since some bacterial species are less susceptible and survive the silver ion exposure while other bacterial species more easily perish. This generates an imbalance in the bacterial community, by which the population of more stubborn bacterial species thrive and the more vulnerable species disappear, thus harming the environment. Apart from the said issues, even in smaller scales some microbial species can develop resistance towards silver ions, and proliferate at ion concentration which hitherto was sufficient to prevent bacterial proliferation.

The present disclosure describes one approach to mitigate the foretold drawbacks associated with using conventional silver as an antimicrobial agent by tightly incorporating silver atoms within a corrosion resistant lattice structure in a manner that its antimicrobial activity is still manifested. In this regard, we synthesized silver perovskite oxides and milled them to nanostructured form. We demonstrated that while having a diminished silver release rate compared to the reference Ag₂O particles, the antimicrobial activity of these nanostructured silver perovskite oxides, quantified by minimum inhibitory concentration (MIC), was down to μg/mL range which rivals the best performance of intensively studied silver nanoparticles. In addition, we demonstrated that the sizes of a significant number of nanostructured aggregates are in the range of a few hundred nanometers. These are sufficiently small to be easily dispersed in an appropriate matrix for synthesizing antimicrobial surfaces.

### SUMMARY

The present disclosure may provide an antimicrobial silver perovskite oxide selected from the group consisting of AgNbO₃ and AgTaO₃, wherein the antimicrobial has a specific surface area of at least 1 m²/g and a silver release rate of less than 0.1% of its weight over 24 hours into deionized water at room temperature.

The antimicrobial silver perovskite oxide may be prepared following the steps of mixing Ag₂O powder with stoichiometric amounts of either Nb₂O₅ or Ta₂O₅ powder, heating the mixture to a formation temperature in the range of 800° C. and 1100° C., staying at the formation temperature for about 4 hours; and gradually cooling down the product to room temperature to obtain a polycrystalline solid. The antimicrobial activity of the polycrystalline solid may be increased by subjecting it to high energy ball milling for a duration of at least 5 minutes to obtain a nanostructured silver perovskite oxide. The specific surface area of the nanostructured silver perovskite oxide and its antimicrobial activity may be further increased by subjecting it to low energy ball milling for a duration of at least 10 minutes.

The antimicrobial silver perovskite oxide may be used for prevention of microbial proliferation in a cooling tower by adding it to the water reservoir of the cooling tower.

The antimicrobial silver perovskite oxide may be used for preparing an antimicrobial surface comprising: dispersing the antimicrobial silver perovskite oxide within a matrix; mixing the dispersion with a binder; and treating the mixture to form a solid with an antibacterial surface.

### BRIEF DESCRIPTION OF THE DRAWINGS

Embodiments will now be described, by way of example only, with reference to the drawings, in which:

FIG. 1 schematically compares the main attributes of the antimicrobial activity of silver to the antimicrobial activities of disinfectants and conventional antibiotics.

FIG. 2 presents the ideal structure of an ABX₆ perovskite with BX₆ octahedron forming the centre of the cube.

FIG. 3A illustrates the steps for synthesizing antimicrobial silver perovskite oxide in flowchart form.

FIG. 3B illustrates the changes in the particle microstructure at different stages of synthesizing nanostructured silver perovskite oxide. In stage (A) the oxide is formed in the form of crystalline grains. The impact force of high energy ball-milling fractures the grains to crystalites during stage (B). The shearing forces of low-energy ball milling or sonication break down the grain into agglomerates of crystallites at stage (C).

FIG. 4 illustrates the XRD spectra of AgNbO₃ obtained by ceramic method at different formation temperatures. The characteristic peaks are indicated by arrows.

FIG. 5A illustrates the specific surface area (g/m²) of nanostructured AgNbO₃ synthesized by ceramic or sol gel method and subjected to various mechanical treatments.

FIG. 5B1 presents TEM images of nanostructured AgNbO₃(C, 90, 120, 0). One of the images at 100000× magnification has been enlarged to demonstrate the detailed structure of a selected nanostructured aggregate.

FIG. 5B2 presents the particle size distribution of nanostructured AgNbO₃(C, 90, 120, 0) as measured by dynamic light scattering (DLS).

FIG. 5C1 illustrates the level of silver ion release from nanostructured AgNbO₃(C, 90, 120, 0) and Ag₂O particles, having similar levels of silver content, into deionized water.

FIG. 5C2 illustrates the level of silver release from nanostructured AgNbO₃(C, 90, 120, 0), nanostructured AgNbO₃(Sg, 0, 120, 0) and Ag₂O powder into deionized water. The samples aliquoted for the ICP analysis were subjected to 30 minutes of centrifugation at 1520 rpm and only the top 9 mL was analyzed for silver concentration.

FIG. 6A illustrates the result of broth microdilution antimicrobial susceptibility of nanostructured AgNbO₃(C, 90, 120, 0) and Ag₂O nanoparticles against Staphylococcus aureus and Pseudomonas aeruginosa bacterial species.

FIG. 6B illustrates a plausible mechanism for glycosidic linkage cleavage through the catalytic action of a catalyst having an hydroxylated silver atom in its surface.

FIG. 6C illustrates the results of increasing nanostructured AgNbO₃(C, 90, 120, 0) concentration on the growth of Escherichia coli cells harvested from a media containing sub-inhibitory levels of nanostructured AgNbO₃(C, 90, 120, 0).

FIG. 6D1 schematically illustrates the size fractionation of nanostructured AgNbO₃(C, 90, 120, 0) during gravitational settling.

FIG. 6D2 indicates the labeling convention of samples taken from different heights. Each indicated height interval is referenced to the bottom of the tube.

FIG. 6D3 presents the agar plate on which Staphylococcus aureus cells were exposed to fractionated nanoparticle suspensions for the exposure time of 30 minutes.

FIG. 6D4 presents the agar plate on which Pseudomonas aeruginosa cells were exposed to fractionated nanoparticle suspensions for the exposure time of 30 minutes.

FIG. 6E illustrates the result of broth microdilution antimicrobial susceptibility of nanostructured AgNbO₃(C, 90, 120, 0) and AgNbO₃(C, 0, 0, 0) against Pseudomonas aeruginosa bacterial species.

FIG. 7 presents the MIC values for nanostructured AgNbO₃ synthesized with different durations of high energy ball milling against Staphylococcus aureus and Pseudomonas aeruginosa bacterial species.

FIG. 8 presents the MIC values for nanostructured AgTaO₃ synthesized with different durations of high energy ball milling against Staphylococcus aureus and Pseudomonas aeruginosa bacterial species.

FIG. 9 presents the MIC values for nanostructured AgNbO₃ treated with different durations of high energy ball milling, using tungsten carbide crucible and balls, against Staphylococcus aureus and Pseudomonas aeruginosa bacterial species.

FIG. 10 presents the MIC values for nanostructured AgNbO₃ synthesized using the ceramic method followed by 90 minutes of high energy ball milling and 0 or 120 minutes of low energy ball milling against Staphylococcus aureus and Pseudomonas aeruginosa bacterial species.

FIG. 11 presents the MIC values for nanostructured AgTaO₃ and nanostructured AgNbO₃ synthesized by ceramic method, treated by 90 minutes of high energy ball milling followed by 0 or 20 minutes of sonication with 60 W, against Staphylococcus aureus and Pseudomonas aeruginosa bacterial species.

FIG. 12 schematically presents an open recirculating type cooling system.

FIG. 13 Left: illustrates the hydration layer on a hydrophilic surface for facilitating the interaction of a microbial cell with the antimicrobial agents bound to the surface. Right: schematically represents the requirement for the density of the exposed nanostructured aggregates on the surface.

FIG. 14 schematically presents the engineered quartz.

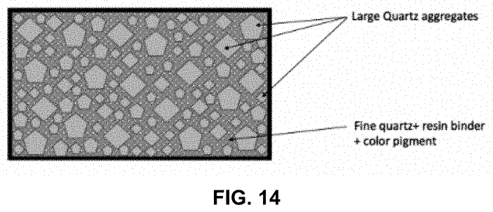

FIG. 15A schematically presents the first stage for assessing antimicrobial resistance.

FIG. 15B schematically presents the second stage for assessing antimicrobial resistance.

### DETAILED DESCRIPTION

Various embodiments and aspects of the disclosure will be described with reference to details discussed below. The following description and the associated drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of the embodiments of the present disclosure.

As used herein, the term “conventional antibiotic” refers to small molecules usually produced by bacteria or fungi that kill bacteria without harming the person or animal being treated.

As used herein, the term “disinfectants” refers to compounds, such as bleach, which are suitable for disinfecting inanimate objects.

As used herein, the term “conventional silver” refers to silver compounds in the form of soluble silver salts such as AgNO₃ and silver (or silver oxide) nanoparticles that can release silver ions into an aqueous medium via dissolution or corrosion.

As used herein, the term “Minimum inhibitory concentrations (MICs)” are defined as the lowest concentration of an antimicrobial that will inhibit the visible growth of a microorganism after overnight incubation [Andrews, J. M. (2001). Determination of minimum inhibitory concentrations. Journal of antimicrobial Chemotherapy, 48(suppl_1), 5-16.].

As used herein, the term “antimicrobial compound” refers to a compound which kills or inhibits the proliferation of at least a class of microbial cells. Without limiting the scope of the present invention and only for the sake of easy characterization, we consider a compound to be antimicrobial if its MIC value against either of Gram-positive Staphylococcus aureus ATCC 29213 and Gram-negative Pseudomonas aeruginosa ATCC 27853 conducted by microdilution susceptibility testing doesn't exceed 128 μg/mL. Here, ATCC stands for American Type Culture Collection.

As used herein, the term “corrosion resistant” describes the ability of a powdered silver containing compound to resist releasing silver ions to the environment by chemical or electro-chemical reactions. We quantify this property by RSRR (Relative Silver Release Rate), which is the ratio of the level of silver released from the compound to a volume of deionized water over a time period of 1 or more days relative to the silver release rate from Ag₂O nanoparticles having a specific surface area of about 1 g/m², with similar amount of silver content and poured into similar volume of deionized water, over similar period of time. For example, if 248.8 mg of the AgNbO₃ powder is poured into 1 L of deionized water and 115.9 mg of the Ag₂O powder is poured in another 1 L of deionized water and after 2 days of storing in room temperature the concentration of the released silver ions is found from these compounds to be respectively 0.1mg/L and 10 mg/L, then RSRR for the AgNbO₃ powder is 1%. Thus, corrosion resistance, as used in the present disclosure, is a relative term. The acceptable upper limit of RSRR depends on application. In preferred embodiment we require RSRR<10%.

As used herein, the “Nanostructured aggregate” is a collection of two or more crystallites whose dimension falls between 1-1000 nanometers. Thus, by the term nanostructured AgNbO₃ we mean aggregates of sub-micron AgNbO₃ particles or crystallites.

As used herein, the “High energy ball milling” is a process in which a powder mixture confined within an oscillating crucible is subjected to impact force from collision with metallic or ceramic balls. The process is used to fracture the crystals in the powder.

As used herein, the “Low energy ball milling” or “Attrition milling” is a process in which a powder mixture confined within a stationary crucible is subjected to shear force from the attrition action of metallic or ceramic beads. In this process the specific surface of the powder is increased.

The study of antimicrobial agents involves two taxonomic domains of Prokarya and Eukarya. The former is divided into two domains; Archaea and Bacteria. The Prokarya and Eukarya domains are most notably differentiated by the fact that Eukaryotic cells contain a nucleus containing the cell's genetic material as well as organelles designated to perform the cell's various functions, while Prokaryotic cells do not possess a nucleus or any other membrane bound organelles. These unicellular organisms are equipped with cell walls made of peptidoglycan. The Fungal cell kingdom, a member of the Eukaryotic domain, are typically unicellular cells equipped with cell walls made of chitin. In contrast to fungi, mammalian cells, also part of the Eukaryotic domain, lack a cell wall. A preferred antimicrobial is expected to kill or inhibit the proliferation of microbial cells while minimally damaging the mammalian cells.

The bacterial cells are classified into two groups, Gram-positive and Gram negative. The differentiating characteristic between them is the construct of the cell wall: The Gram-positive bacteria are equipped with a thick peptidoglycan cell wall over their bilayer membrane, while the relatively thin cell wall of the Gram-negative bacterial cells is sandwiched between two bilayer membranes. For our studies on the antimicrobial action of the nanoparticles in the present work, we have selected Pseudomonas aeruginosa and Staphylococcus aureus, respectively, as the representatives of Gram-negative and Gram-positive bacteria. Also, we have illustrated the broad-spectrum antimicrobial action against Candida albicans. This is a significant observation as the conventional antimicrobials are not typically effective against both bacterial and fungal species.

An appropriate antimicrobial agent should target microbial cells without harmfully impacting mammalian cells. Therefore, the agent must target those building blocks which are unique to the microbial cell types. For instance, bacterial cells, unlike mammalian cells, have cell walls. Thus, a compound which inhibits the synthesis of the cell wall will have no effect on mammalian cells but will eventually kill the bacterial cell as there will be no supply of material for maintaining the cell wall and the cell will burst under the osmotic pressure from aqueous ambient.

Unlike mammalian cells, in bacterial cells the cytoplasmic membrane, i.e. a two-molecule thick phospholipid bilayer in which numerous proteins are embedded, is surrounded by the cell wall. The cell wall in gram-positive bacteria is a thick (15-80 nm thick) peptidoglycan layer on the outside of the cell membrane. In contrast, the thinner cell wall (approximately 3 nm of peptidoglycan layer) of the gram-negative bacteria is sandwiched between two cell membranes. One group of antibiotics, known as ß-lactams, mimic a section of the bacterial cell wall, and inactivate enzymes which are normally involved in assembling cell walls. Thus, the cell is deprived of the mechanical support of the cell wall against osmotic forces burst open (lyse) and eventually dies.

The genomic Deoxyribonucleic acid (DNA) is the part of DNA that carries the hereditary information of an organism from one generation to the next. During cell division, the DNA is copied and each daughter cell carries one copy. Any damage to the DNA, if not repaired, will impede cell division. A class of antibiotics, known as Quinolones, cause bacteria to cut their own DNA, but prevent them from repairing the damage.

Genes are the hereditary segments carried by the genomic DNA. In order to maintain the cell function, the information on these genes are transcribed onto a type of Ribonucleic acid (RNA) molecules, which are designated as messenger RNA (mRNA). The information on mRNA is then translated into specific sequences of structural and functional (enzyme) proteins with the mediation of transfer RNA (tRNA). The machinery which performs this protein synthesis task is ribosome, a complex composed of ribosomal RNA (rRNA) and associated proteins. Mammalian cells also contain ribosomes, but the structure and functioning of these differ significantly from the bacterial ribosomes. Accordingly, one group of antibiotics, named as tetracyclines for containing a four-ring structure, specifically inhibit bacterial cells from making proteins. Bacterial cells that are unable to make proteins can no longer grow or divide, allowing the host body immune system enough time to destroy them. Macrolides are another class of antibiotics, which like tetracyclines, prevent bacteria from making proteins. Another major group of antibiotics known as aminoglycosides, are known for having sugars (glycosides) with attached amino (NH₂) groups. These perturb the ribosomes and disrupt their function. Consequently, the produced malformed proteins are often lethal to the bacterial cell.

There are other antibiotics that don't fit neatly into any of the groups mentioned above. They damage bacterial cells through processes such as preventing RNA synthesis, inhibiting cell wall synthesis, damaging bacterial membranes, and causing uncontrolled flagella movement.

The antimicrobial action of conventional antimicrobials are determined by the antimicrobial susceptibility tests (AST), whose outcome is quantified by minimum inhibitory concentration (MIC) values. The MIC is defined as the lowest concentration of an antibiotic that will inhibit the visible growth of a well characterized concentration of the target microbial cells after overnight incubation. The gold standard method for performing AST is broth microdilution test, which involves growing microbial cells inside polarity of wells on a microwell plate containing growth media. Each well is supplied with different concentrations of the antimicrobial agent, typically differing by a factor of two from one well to the next. Known number of microbial cells in the range of 10⁵ CFU/mL (CFU=colony forming unit, meaning a cell that is viable and can divide) is dispensed into each well. After overnight incubation, the wells are inspected for signs of growth by visual inspection or turbidimetry. Thus, the minimum concentration required to inhibit growth is determined. Another alternative to broth microdilution AST, is the agar dilution AST. In this method, the antimicrobial agent at a specific concentration is mixed with agar gel. The target microbial suspension is streaked on the plate and the growth behavior of microbial cells is evaluated after overnight incubation.

The MIC values of known antibiotics are in the μg/mL range. For instance, the MIC of Ceftriaxone against Pseudomonas aeruginosa and Staphylococcus aureus is, respectively, 8 and 2 μg/mL. On the other hand, the MIC of Cefadroxil against the same bacterial cells is, respectively, >128 and 2 μg/mL [Andrews, J. M. (2001). Determination of minimum inhibitory concentrations. Journal of antimicrobial Chemotherapy, 48(suppl_1), 5-16.]. In this case, because of the large level of MIC, it is said that Pseudomonas aeruginosa is not susceptible to Cefadroxil because using higher concentration of the antibiotic (over 128 μg/mL) will be hazardous to human cells.

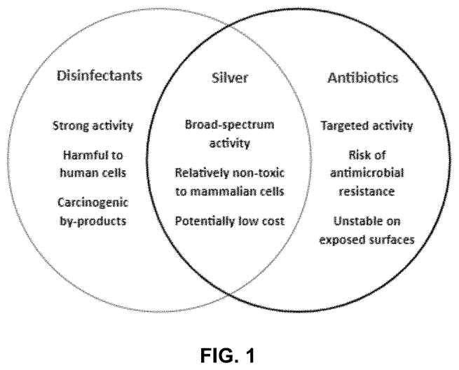

It is known from the prior art that both silver ions and silver nanoparticles show broad-spectrum antimicrobial activities against gram-positive and gram-negative bacteria and also fungal cells and are much less likely to induce antimicrobial resistance as compared with the conventional antibiotics. So, in terms of breath of antimicrobial action, silver is more similar to disinfectants; However, in contrast to disinfectants, silver is relatively non-toxic to mammalian cells. This point of view is summarized in FIG. 1. Thus, Silver is a relatively good active agent for the antimicrobial surfaces.

Conventional silver is a broad-spectrum antimicrobial agent. The antimicrobial action of these compounds are thought to be due the mechanisms including: (i) structural changes in the bacterial membranes, (ii) inhibition of the enzymes of the respiratory chain, and consequently, decoupling of respiration from ATP synthesis, (iii) formation of reactive oxygen species (ROS), and (iv) lesions in DNA, affecting chromosome replication ability [Wyszogrodzka, Gabriela, et al. “Metal-organic frameworks: mechanisms of antibacterial action and potential applications.” Drug discovery today 21.6 (2016): 1009-1018.]. These effects are supposed to be due to the interaction of the Ag⁺ ions with electron-donating groups of biomolecules, such as thiols (—SH), carboxylates, amides, imidazoles, indoles and hydroxyls. A review of selected studies on the antimicrobial action of silver nanoparticles indicates that the MIC of silver nanoparticle in 10-20 nm size range against Staphylococcus aureus and Pseudomonas aeruginosa, is respectively in 25 to 50 μg/mL and 12 to 40 μg/mL ranges.

The exposure of a large number of bacterial cells to an antimicrobial agent with concentration above MIC value, will inhibit their proliferation and none of the cells will be able to reproduce. However, if the agent's concentration is under the lethal dose, some bacterial cells will survive the stress and may transmit the ability to the next generation. Thus, the cells grown under stress over multiple generations may become efficient in tolerating the external insult. A common mechanism accounting for the development of antimicrobial resistance is the random chromosomal mutations that may lead to an altered protein with properties different from those produced in the wild type (normal) bacteria.

As we mentioned above, silver and silver nanoparticles exert their antimicrobial action via interacting simultaneously with multiple targets in the microbial cell. Therefore, both silver ions and silver nanoparticles show broad-spectrum antimicrobial activities against gram-positive and gram-negative bacteria. Moreover, if silver-target interaction pathways are truly independent, then the induction of antimicrobial resistance is much more unlikely than the case of conventional antibiotics, because this will require simultaneous mutations. Still, resistance against silver has been reported in the literature. Like the case of conventional antibiotics, bacterial cells, which are repeatedly exposed to subinhibitory concentrations of silver nanoparticles, may develop resistance to their antibiotic activity. The major mechanisms could be either exclusion of silver ions from the bacterial cell by efflux pumps or via the protective role of the extracellular polymeric substances (EPS) produced by bacteria while growing on surfaces and forming biofilms.

The main drawback of the conventional silver is due to its mechanism of action, which is hypothesized to be exerted via the silver ions released to the environment. This arises complications such as decreased lifetime, environmental contamination, and possible channels for the microbe to survive when exposed to small doses of silver ions. The present invention discloses using silver as the active agent in a manner which counters the said drawbacks by tightly bonding silver atoms in the structure of a corrosion resistance structure.

Antimicrobial Silver Perovskite Oxide Nanoparticle Aggregates

Silver can be incorporated in the structure of corrosion resistant oxides for substantially slowing down the rate of its release into aqueous media. These oxides can be in the form of perovskite, spinel, or brownmillerite structure. In this disclosure we have selected perovskite oxide as a representative case with the goal of illustrating the manner by which the synthesis and post-synthesis procedures may be adjusted to enhance the antimicrobial activity of the resulting nanostructure compound.

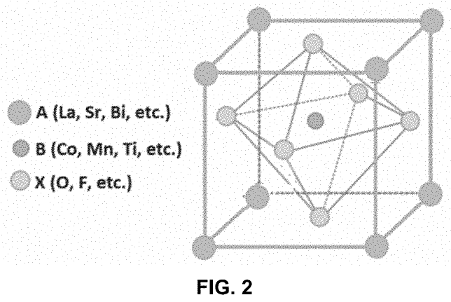

Perovskites are generally a family of ionic compounds which have a general formula of ABX₃, and their structure can be viewed as the BX₆ octahedron forming the center of a cube with the larger metal A atoms occupying its corners as presented in FIG. 2. The coordination number of A and B cations are 12 and 6, respectively. The perovskite structure is generally adopted by most oxides with the general formula ABO₃. The intrinsic properties of perovskite structure, most notably oxygen mobility and ion vacancies make them the ideal candidate for catalytic applications. Up to half of the B cation can be replaced by a different cation B′, resulting in the double perovskite formula, A₂BB′O₆ where the A cations are surrounded by an alternating network of BO₆ and B′O₆ octahedra. In addition, the oxygen nonstoichiometry including both oxygen deficiency and oxygen excess is common, such that the overall charges of the A and B cations are less or greater than the charges of the oxygen anions (six). Thus, a perovskite compound may have a more general formula A₁₋ₓA′ₓB_{1-y}B′_{y}O_{3±δ}, where “+δ” and “−δ” respectively denote oxygen excess and oxygen deficiency.

Two known silver perovskite oxides are AgNbO₃ and AgTaO₃. Still, other silver perovskite oxides with general formula AgBO₃ with B being another element may be a possibility, provided that the resulting compound has sufficiently low level of silver release rate and also be amenable to processes needed to provide it in nanostructured form.

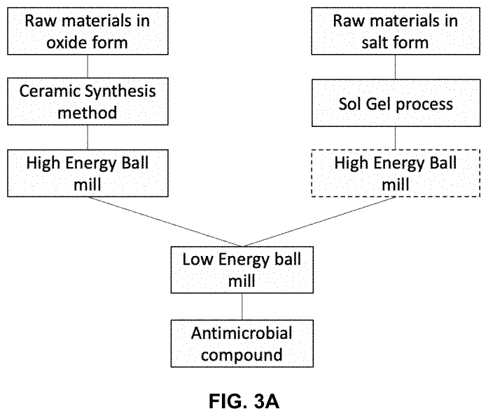

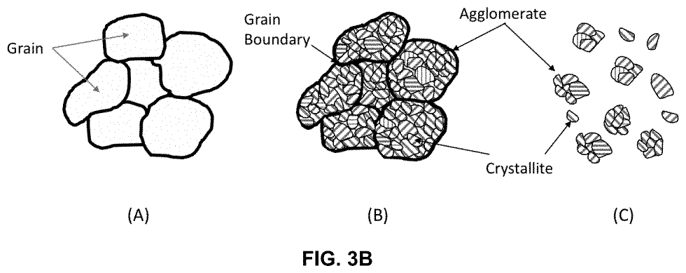

The procedure for synthesizing antimicrobial silver perovskite oxide is presented in FIG. 3A in flowchart form. It includes four steps of mixing raw material in appropriate ratio, forming polycrystalline perovskite, fracturing the crystals by high energy ball milling, and separating agglomerates by low energy ball milling. In the case of the sol-gel method the high energy ball milling may be skipped if the formation temperature is kept at values less than 600° C. However, this comes with the drawback of having excess unreacted silver which gives rise to high silver release rate.

There are two methods for the synthesis of perovskite compounds from raw materials: the solid state method (also known as ceramic method) and wet chemical reaction method; i.e. sol-gel method. In the ceramic method the perovskite oxide is synthesized from metal-oxide precursors by high-temperature heat treatment. The sol-gel method is commonly used for the synthesis of perovskite compounds, is a simple method for obtaining perovskites with relatively high surface areas. In this method, the solution “sol”, which includes the salts of metals A and B, gel precursor, and appropriate additives, are gradually converted to a gel with methods such as heating or freeze-drying. Then, the dried gel is calcined and homogeneous perovskite oxide is obtained. The intimate and homogeneous mixture of the precursors in the gel results in low diffusion distance, which allows synthesizing the perovskite at relatively low temperatures, thus inhibiting undesired grain growth.

The resulting nanostructured aggregates may be characterized in terms of various properties, including specific surface area, crystallographic structure, silver ion release rate, sedimentation rate in different media, and aggregation characteristic as inspected with transmission electron microscopy (TEM) as will be described in examples. Then, the antimicrobial activity of AgNbO₃ nanostructured aggregates were measured by both broth microdilution and solid phase methods, respectively and compared with the activity of the reference Ag₂O nanoparticles.

In the following we describe the ranges of synthesis steps that determine the antimicrobial activities of the nanostructured silver perovskite oxides.

Synthesis of AgNbO₃

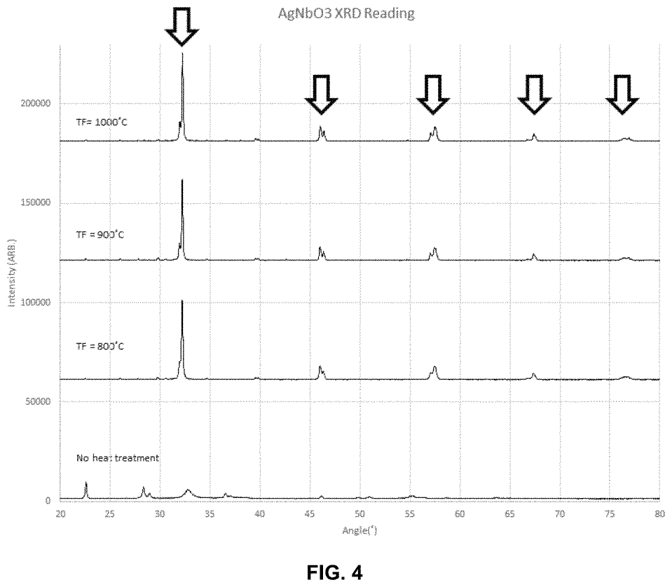

The formation temperature of the compound is the main parameter in the synthesis procedure. In order to find the preferred range for this parameter, we prepared the compound at various selected temperatures, including 800, 900, 1000, and 1100° C. according to the procedure of Example 1. The range of appropriate formation temperature was assessed by inspecting the physical condition of the ceramic and its XRD peaks. For instance, in the case of preparing AgNbO₃, it was observed that the high temperature of 1100° C. was not appropriate because the elemental stoichiometry could no longer be kept at temperatures higher than 1100° C. The selection between the three lower temperatures was based on comparing the XRD spectra at the characteristic peaks as presented in FIG. 4. As it is observed at the reaction temperature of 800° C. the peak at ˜77 degree is not pronounced. The peaks are sharpest at 1000° C. and all peaks related to the precursor oxides disappear, suggesting that no significant unreacted precursor remains within the perovskite. Thus the formation temperature between 800° C. and 1100° C. is our preferred formation temperature. More preferably, the formation temperature is selected to be between 900° C. and 1050° C.

Throughout the examples we have selected the duration of perovskite formation to be 4 hours. Evidently, longer times are not expected to impact the performance of the final product. However, shorter times may not be sufficient for completion of the synthesis, particularly when the formation temperature is in the lower range (less than 900° C.). In one embodiment the duration of formation is at least 30 minutes. In the preferred embodiment the duration of formation is at least 2 hours.

The compound was also synthesized employing the sol-gel method according to the procedures of Example 2. In this case the calcination was performed at a temperature of 550° C. for 2 h. This temperature must be carefully chosen in order to complete the reaction of the precursors while keeping the final crystallite size as small as possible. Too low a temperature results in the presence of unreacted precursor and too high a temperature results in excessive crystallite growth. According to our experiments, the preferred range of the calcination temperature is selected in the range 500° C. and 700° C. and the calcination time is in the range 1h to 3 hours.

The sol-gel method requires more expensive raw material (nitrates) and generates large amounts of chemical waste. In contrast, the high energy ball milling treatment required for the ceramic synthesis method is easily scalable, requires low cost raw material (oxides) and leaves behind no waste.

Though the silver perovskite oxide is synthesized employing either Example 1 or Example 2 may have some antimicrobial activity, its level is not sufficient for most practical uses. One main aspect of the present invention is to enhance the level of this antimicrobial activity to render the compound useful in practice. We realize this by subjecting the compound to mechanical treatments, including high-energy ball milling, low energy ball milling, and sonication, as described below.

In order to illustrate the effects of mechanical treatment on the microstructure of the ceramic we have schematically presented in FIG. 3B the main procedures and their outcome for the case of the ceramic synthesized by ceramic method. The synthesis procedure typically gives rise to a solid compound in the form of micron size polycrystalline grains. These grains are then fractured to nano-sized crystallites, typically by a high energy ball milling process. At the end of this step the agglomerate of nanosized crystallites are still tightly bound together, possessing a typically low exposed surface area. At the next stage, the agglomerates are broken into smaller agglomerates or even individual crystallites under the shear stress, exerted by procedures, such as low energy ball milling process. These are more easily suspended in liquid media or solid matrices.

AgNbO₃ at the end of the ceramic process has a yellowish color. This compound with a bandgap energy of 2.8 eV (absorption wavelength of ˜440 nm) is an electrically insulator ceramic. On the other hand, further processing the ceramic makes it darker, such that after high energy ball milling for over 30 minutes the material is visibly black. This indicates strong light absorption over all visible regions, meaning that the electrons of the valence band can be excited to the conduction band via intermediate energy levels by the absorption of two or more photons. Thus, during the ball milling process extra energy levels have been created between the valence and conduction bands of the crystal due to the generation of crystal defects and surface irregularities. The said energy levels also indicate enhanced activation of the silver atoms on nanoparticle surfaces, particularly, at edges and corners. Without being bound by the theory, we speculate that these exposed silver atoms can have strong catalytic activity or chemical reactivity with the surfaces of the microbial cells or the contents of the aqueous media that fills the space between the cells and agglomerates. Thus, the process of grain fracturing and deagglomeration enhances the antimicrobial activity in two respects; 1) increasing the number of particles for a given mass of the compound and accordingly enhancing the chances of cell-particle contact, and 2) increasing the activity of exposed silver atoms. The later mechanism is based on the established view that the change in the band gap has strong influence in the chemical reactivity of oxides [Fernandez-Garcia, M., et al. “Nanostructured oxides in chemistry: characterization and properties.” Chemical Reviews 104.9 (2004): 4063-4104].

In the description below we adopt a notation for labeling the compounds in terms of synthesis procedure and post-synthesis treatments: The chemical formula of the compound is followed by a character and three numbers inside the parentheses. The character, either C or Sg, respectively, indicates the synthesis procedure by “ceramic method” of example 1 or “sol-gel method” of example 2 below. The next three numbers, respectively indicate the durations (in minutes) of high-energy ball milling of example 3, low-energy ball milling of example 4, and sonication with 60 W of input power of example 5. Thus, the notation AgNbO₃(C, 90, 120, 0), indicates that AgNbO₃ was synthesized by ceramic method, and was treated with 90 minutes of high energy ball milling, 120 minutes of low energy ball milling, and 0 minutes of sonication.

The Reference Ag₂O as a Representative of Conventional Silver

We have used nanostructured Ag₂O as an example of the conventional silver standard for evaluating the antimicrobial activity and the level of corrosion resistance. Ag₂O in micron size powder form was purchased from Sigma-Aldrich Corp and was subjected to high energy ball milling for 90 minutes. The result is particle aggregates with specific surface area of under 1 m²/g as determined by the procedure of Example 6. Throughout the rest of this disclosure, we will refer to this particle aggregates with the term “silver oxide”.

Silver oxide is speculated to be through the release of Ag⁺ ions to the ambient via the following equation:

½Ag₂O(s)½H₂O→Ag⁺_{(aq)}+OH⁻_{(aq)} with log K=−7.71

At pH 7, the solubility is high. However, as the reaction proceeds in water and more OH⁻ ions are generated, the pH increases and accordingly the solubility decreases.

Imparting the antimicrobial property of the silver compounds by mechanisms other than the release of silver ions can mitigate the drawbacks associated with the conventional silver. Thus, we decided to incorporate silver atoms in a perovskite structure and surprisingly found antimicrobial activity comparable to the corresponding activity of the “silver oxide” particles, provided that the said perovskite be subjected to mechanical treatments with appropriately selected parameters.

Specific Surface Area, Size and Morphology of Nanostructured Aggregates

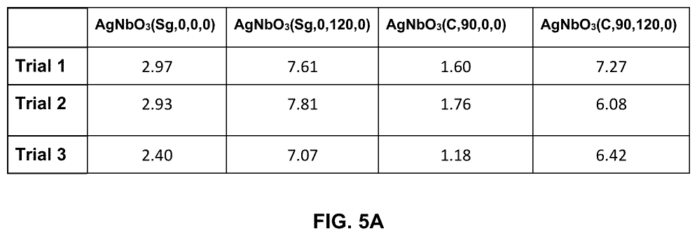

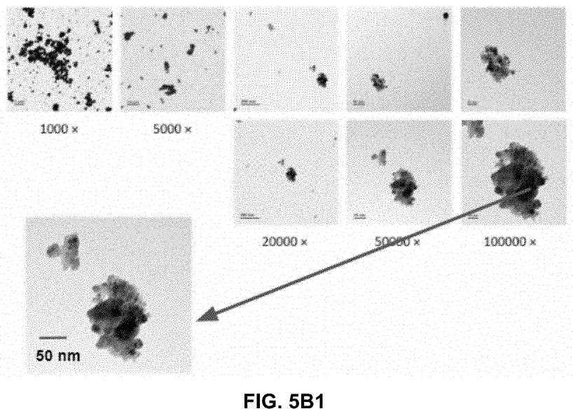

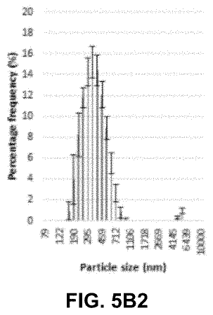

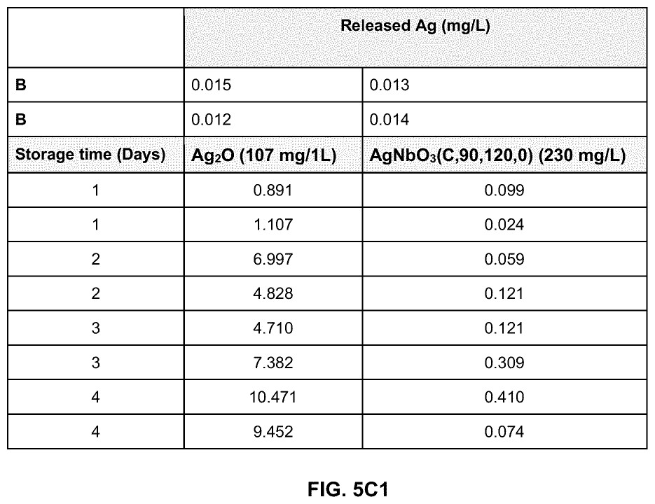

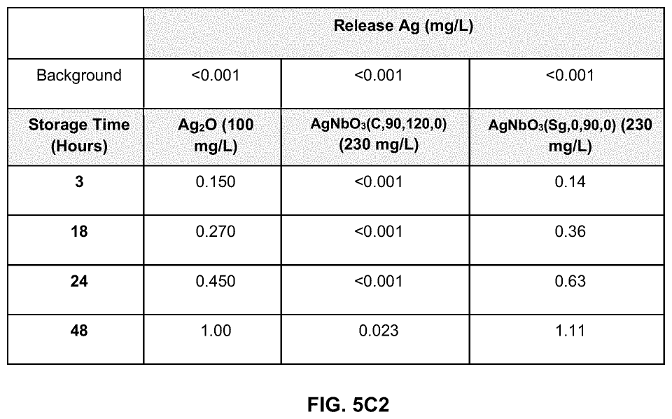

The specific surface area of AgNbO₃(C, 90, 120, 0) nanostructured aggregates was determined according to the method of example 6 and the result was presented in FIG. 5A. As it is observed the low energy ball milling treatment significantly increases the specific surface area of the nanostructured aggregates.

In FIG. 5B1 we show the TEM images of dried AgNbO₃(C, 90, 120, 0) prepared according to the procedure of Example 7. In this case the crystallites have been created from the single crystals of the original compound by the high energy ball milling and some of them have been separated by the low energy ball milling treatment.

The size distribution of nanostructured aggregates in AgNbO₃(C, 90, 120, 0) was measured by Dynamic Light Scattering (DLS) according to the procedure of Example 7 and presented in FIG. 5B2. The main attributes of this plot are the mean particle size and polydispersity index (PDI). The later quantity is defined as PDI=(std/mean)², where std is the standard deviation of the particle sizes. These quantities have been measured to be 438.25 nm and 0.308, respectively. It is known that a PDI of smaller than 0.05 corresponds to monodisperse particles and a PDI value of larger than 0.7 indicates that the sample has a very broad particle size. Thus, the distribution of the sizes in the present case can be judged to be moderately homogeneous.

Assessing Corrosion Resistance

As it was described above, we employ the amount of silver ion release from the silver perovskite oxide nanostructured aggregates into deionized water as an indication for corrosion rate. This is justified on the grounds that the release of silver ions into the ambient negatively impacts the environment. In addition, the aggregate loses its utility over time as the exposed silver atoms on the nanoparticle surface is the main determinant of the antimicrobial activity.

The general test procedure for measuring silver ion release involved submerging the particles inside deionized water over time intervals ranging from hours to days. Since the released silver ion level in the case of AgNbO₃ nanostructured aggregates was low, the measurement was judged to be significant only when it exceeded the threshold level with a confidence level of 95%. For this end the Limit of Blank (LoB) of the ICP device was determined by testing replicates of a sample containing no particle. Then, LoB was determined using the relation

LoB=mean of blanks+1.645 (standard deviations of blanks)

A measured value was judged significant if it was above LoB. One set of measurements was made disregarding the possibility that small AgNbO₃ nanostructured aggregates resulted in the overestimation of the silver release rate. Of course, this issue may also influence the silver release rates from Ag₂O particles, but since these particles are estimated to be larger (estimated from the specific surface measurements) they are less likely to be present in the suspension.

Protocol:

1. Two beakers were filled with 1 L of deionized water.

2. Two 10 mL samples were taken from each of the beakers and were marked as blanks.

3. 230 mg/L AgNbO₃(C, 90, 120, 0) was added to the first beaker.

4. 107 mg/L Ag₂O was added to the second beaker.

Note: the weight of the AgNbO₃(C, 90, 120, 0) nanostructured aggregates are selected such that its silver content is similar to the silver content of its corresponding reference Ag₂O particles. Also, note that the molar masses of AgNbO₃ and Ag₂O are respectively 231.72g/mol and 248.76g/mol.

5. The beakers were stored at room temperature for allowing particles to settle. At time points (1, 2, 3, 4) days two samples with volumes of 10 mL were taken from each of the beakers and sent for silver concentration analysis by ICP (Inductively Coupled Plasma mass spectrometry).

The measurement results are presented in FIG. 5C1. The time points labelled as “B” are the blank samples. The LoB was determined by taking the average and standard deviation of the measurements on 8 blank samples. In this case LoB was determined to be 0.015. Using the measured value at day 2, the silver release of Ag₂O was calculated to be an average of at least 65 times larger than that of AgNbO₃, meaning that the quantity RSRR of about 1.5%. This is a lower estimate, as the signal from suspended particles in the case of AgNbO₃ may have significant contribution from the suspended particles. This inference is also supported by the relatively larger standard deviation of the data corresponding to AgNbO_{3.}

The test reported above indicated that the rate of silver release from AgNbO₃ nanoparticles was at least 65 times lower than the corresponding rate from Ag₂O particles having similar silver content. The most evident culprit was identified as the possibility of some nanoparticles remaining suspended in water and being falsely detected as silver ions by the ICP. The silver release test from AgNbO₃ nanoparticles is more prone to this as they are more likely to remain in suspension phase within the liquid media rather than settling to the bottom compared to Ag₂O. This is chiefly due to the size of the particle, as according to Stoke's law the settling rate of spherical particles is proportional to the square of radius. Thus, one straightforward way to eliminate the measurement artifact is to accelerate the particle settlement by centrifuging them. Adopting this approach the measurement protocol was modified, such that the aliquoted samples for the ICP analysis were subjected to 30 minutes of centrifugation at 1520 rpm and only the top 9 mL was analyzed for silver concentration.

The result is presented in FIG. 5C2 for the case of AgNbO₃(C, 90, 120, 0) and AgNbO₃(Sg, 0, 120, 0). In this case the ICP instrument had a lower background, perhaps because of system re-calibration. The measured RSRR of 2.3% at two days is not significantly different from the 1.5% which we had obtained without centrifugation of the aliquoted samples before the ICP analysis. The difference can also be attributed to the batch to batch difference of AgNbO₃(C, 90, 120, 0) samples. Alternatively, we can argue that the centrifugal force is not sufficiently high to settle the individual nanoparticles.

In the preferred embodiment we desire to limit RSRR to less than 20%. According to the data of FIG. 5C1 this translates to an upper limit of about 0.1% of the weight of the nanostructured silver perovskite.

A significant RSRR of 111% was observed for AgNbO₃(Sg, 0, 120, 0) sample. This can be explained by noting that AgNbO₃(Sg, 0, 120, 0) nanostructured aggregates have a specific surface area of at least 7 times larger than the surface area of Ag₂O particles so is at least 7 times more vulnerable to corrosion.

The high silver release rate from AgNbO₃(Sg, 0, 120, 0) is speculated to be due to the presence of the unreacted silver on the nanoparticles. In order to mitigate this undesired outcome higher calcination temperature and time are required. However, this in turn results in undesired grain growth resulting in lower antimicrobial activity as will be demonstrated below.

Quantification of the Antimicrobial Activity

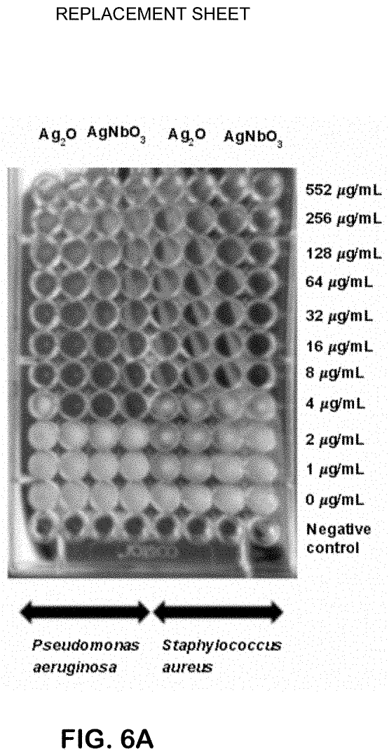

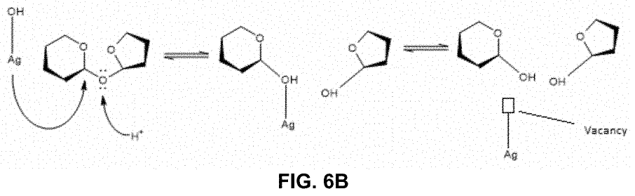

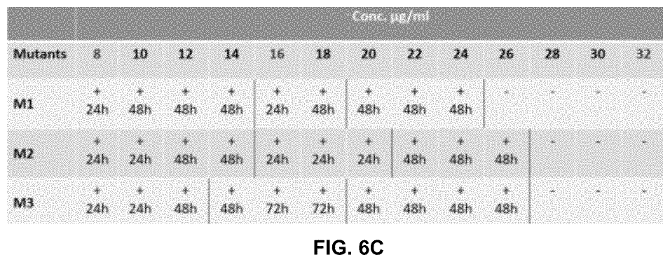

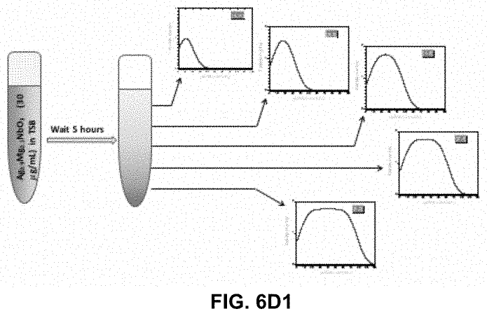

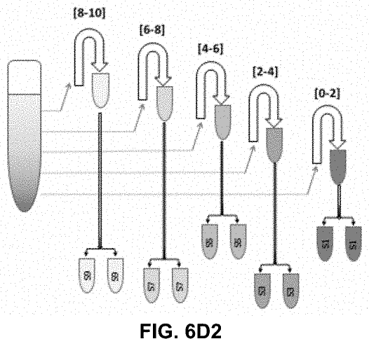

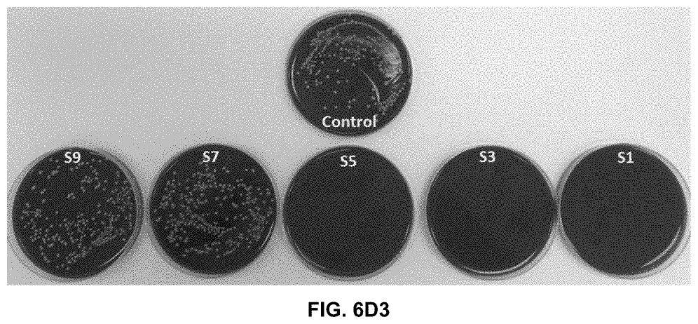

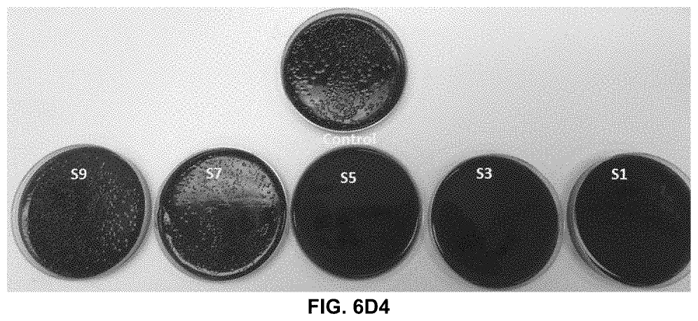

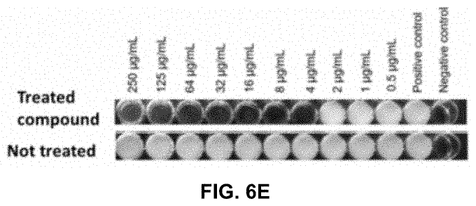

Antimicrobial activity was performed by broth microdilution method according to the procedure of example 8A against pathogenic Staphylococcus aureus and Pseudomonas aeruginosa bacterial cells, both of which are important in the context of hospital acquired infections. Staphylococcus aureus and Pseudomonas aeruginosa from American Type Culture Collection (ATCC) were used, respectively, with ATCC #29213 and ATCC #27853. The pictures of the sample plate in the case are presented in FIG. 6A. In this case, the MIC for the case of Staphylococcus aureusand Pseudomonas aeruginosa is, respectively, 8 and 4 μg/mL for both AgNbO₃(C, 90, 120, 0) nanostructured aggregates and Ag₂O.

We repeated the experiment above for the case of AgNbO₃(Sg, 0, 120, 0) and found out that its antimicrobial activity is similar to the activity of AgNbO₃(C, 90, 120, 0).

The antimicrobial activity of AgNbO₃(C, 90, 120, 0) nanostructured aggregates and Ag₂O against Staphylococcus aureus and Pseudomonas aeruginosa bacterial cells were also measured by agar dilution method according to the procedure of example 9. The MIC was measured to be 10 μg/mL for both types of nanoparticles and bacterial cells.

The antimicrobial activity of AgNbO₃(C, 90, 120, 0) nanostructured aggregates against Candida albicans ATCC #10231 was performed using agar dilution method according to the procedure of example 9. The MIC value was 25 μg/mL. This value is not much above the MIC of 10 μg/mL, measured by agar dilution AST for Staphylococcus aureus and Pseudomonas aeruginosa.

A good antimicrobial should be relatively safe for mammalian cells. In this respect, the effect of AgNbO₃(C, 90, 120, 0) nanostructured aggregates on human cell line MRC-5 and Hep-2 were studied. These cell lines are commonly used for studies on the hazards of environmental contaminants. It was demonstrated that incubating these cells in a media containing up to 60 μg/mL of AgNbO₃(C, 90, 120, 0) nanostructured aggregates did not result in cell death, cytopathogenic effect (CPE) or any other damage to the cell was observed. The observation that the same concentration was sufficient to kill gram positive, gram negative, and fungal cells, is intriguing because these cells are mechanically much tougher than mammalian cells because of having cell walls.

The similar levels of antimicrobial activity for the AgNbO₃(C, 90, 120, 0) nanostructured aggregates and Ag₂O is an important observation. As presented above, the silver ion release rate between these types differed by a factor of about 150 folds. Therefore, if the Ag⁺ ions were the only determinant of bactericidal property then Ag₂O should have a MIC value 1/150 of the MIC value for AgNbO₃(C, 90, 120, 0). The fact that we have measured a similar value for the MIC of AgNbO₃(C, 90, 120, 0) nanoparticles indicates that silver ion release is not the main determinant of bactericidal property for this compound.

Without intending to be limited by theory, it is suspected that the antimicrobial activity of the AgNbO₃ nanostructured aggregates is catalytic in nature. This speculation is based on the reported catalytic activity of perovskite oxides in oxidation reactions and the analogy with the activity of Polysaccharide monooxygenases (PMOs) enzymes secreted by fungal species for the degradation of biomass to simpler saccharides. In these enzymes the main role is played by the copper atom which is in the same group as silver in the periodic table sharing similar properties. The main function of copper and its surrounding molecular structure is to enable the oxidation reaction with triplet oxygen molecules, which is forbidden by spin selection rule. The reaction starts with the enzyme having an oxygen deficiency site on the Cu atom. An oxygen molecule is adsorbed on the vacancy site. In the presence of two H⁺ ions, provided by the cofactor, one of the oxygen atoms is removed by formation of a water molecule leaving behind an oxygen radical attached to Cu. This process is of utmost importance; an oxygen atom, which due to being in triplet spin state is unable to react in oxidation reactions as it would violate the spin selection rule, now has transformed into a species that can easily oxidize other molecules. Thus, when a polysaccharide molecule comes into contact with the enzyme, its C₁ forms a Cu (II)-OH complex. Then, via an oxygen-rebound mechanism, the OH group is transferred back to the polysaccharide molecule. After this process the enzyme goes back to its initial state (definition of catalytic action) and the polysaccharide that has exchanged its H atom at Ci to an OH group is rendered unstable and its glycosidic linkages between two adjacent sugar units are cleaved. Accordingly, a catalytic reaction, depicted in FIG. 6B, is suggested by which the glycosidic bond between the two sugar units of microbial cell wall is cleaved in the presence of H⁺ cofactor, which is provided by the proton pumps in the form of membrane proteins of bacterial, fungal and plant cells (but not mammalian cells).

Apart from the cleavage of the glycosidic link by catalytic action of AgNbO₃ nanostructured aggregates in the presence of H⁺cofactor peroxidation of cellular lipids by silver atoms may also contribute to antimicrobial activity. Our rationale for the hypothesis is based on the findings implying that the antimicrobial effect of silver ions is due to their effects on reactive oxygen species (ROS), such as H₂O₂ and hydroxyl radicals, which are produced by not well-established mechanisms. Indeed, this mechanism is also speculated to involve the respiratory chain of the microbial cells.

The Effect of Gravitational Settlement on the Antimicrobial Activity of Nanostructured Aggregates

The susceptibility experiments described so far addressed the antimicrobial effect of polydispersed AgNbO₃(C, 90, 120, 0) nanostructured aggregates for the cases of interactions that lasted overnight. Here, we present the result of microbial cells' interactions with fractionated nanostructured aggregates.

A nanoparticle suspension with concentration of 30 μg/mL and a volume of 10 mL was prepared in 15 mL centrifuge tube. The particle fractionation occurred by allowing the suspension to gravitationally settle during a 6 hour period and generate an aggregate size distribution as schematically presented in FIG. 6D1. Then, aliquots with volumes of 2 mL were pipetted from different sections of tube without perturbing the underneath liquid content. Each aliquot was mixed with vortexing and is splitted to two 1 mL samples in 1.5 mL microcentrifuge tubes. The labeling convention for these samples is according to FIG. 6D2.

Each microcentrifuge tube was spiked with about 500 CFU of either Pseudomonas aeruginosa or Staphylococcus aureus. After waiting for exposure time of 30 minutes 200 μL of the tube's content was plated on an agar plate and the plates were incubated at 37° C. for overnight. The next day the plates were photographed and presented in FIGS. 6D3 and 6D4 for the cases of Staphylococcus aureus and Pseudomonas aeruginosa, respectively.

As it is observed, Staphylococcus aureus exposed to the nanoparticle suspensions taken from height intervals [8, 10] (S9) and [6,8] (S7) had survived and formed colonies, but the suspensions from lower heights impeded the bacterial growth. In the case of Pseudomonas aeruginosa cells, like the case of Staphylococcus aureus, the cells exposed to S1, S2, and S3 fractionated nanoparticle suspensions for 30 minutes were killed. The cells exposed to S7 and S9 survived. However, the morphology of the formed colonies were visibly different from the colonies on the control plate. The cells appear to have survived but their reproduction rate has slowed down.

The observations of this subsection imply a kind of threshold behavior. Apparently, the small non-settling nanostructured aggregates of S7 and S9 are not very effective at killing bacterial cells. However, the medium size aggregates that have travelled down to S5 and below are very effective. It is speculated that these include some minimum number of nanoparticles and their simultaneous interaction with cells is fatal.

Assessing the Development of Antimicrobial Resistance

A premise for the superiority of AgNbO₃ nanostructured aggregates as antimicrobial agents is their expected resiliency in terms of developing antimicrobial resistance. This advantage was illustrated by selecting Escherichia coli ATCC 25922 as the target microbial cell. First, the growth curve of this bacteria, prepared in the presence of different concentrations of AgNbO₃(C, 90, 120, 0) nanostructured aggregates in the TSB media, was measured and the MIC value was found to be 10 μg/mL. Thus, the experiment of example 8B was performed starting from the concentration of 8 μg/mL and incubating the harvested cells in a media containing higher concentrations of AgNbO₃(C, 90, 120, 0) nanostructured aggregates and the results of FIG. 6C was obtained. As it is observed, we could not adapt the cells to concentrations of above 26 μg/mL. It is remarkable that employing silver nanoparticles as antimicrobial agents the MIC value can shift by many folds. For instance, Panaaek et al. [“Bacterial resistance to silver nanoparticles and how to overcome it.” Nature Nanotechnology 13.1 (2018): 65-71] have shown that the MIC value of 28 nm silver nanoparticles against Escherichia coli CCM 3954 was shifted from 3.38 μg/mL to 54 μg/mL, i.e. about 16 folds over six generations.

The Stability in Aqueous Media of Compounds in Terms of Antimicrobial Activity

Following the procedure described above, the MIC values were measured for two samples of AgNbO₃(C, 90, 120, 0) nanostructured aggregates. One of the samples was kept in dry form and the other was kept in water for a duration of 5 months. The measured MIC values against Staphylococcus aureus and Pseudomonas aeruginosa didn't show any difference. Thus, storage in water had no degrading effect in antibacterial activity.

The Stability in Aqueous Media of Compounds in Terms of Antimicrobial Activity

Employing the procedures of Example 1, the silver atoms of AgNbO₃ were partially substituted by Mg, Ca, and Sr during the synthesis to obtain perovskites respectively with formula Ag_{0.9}Mg_{0.1}NbO_{3-δ} , Ag_{0.9}Ca_{0.1}NbO_{3-δ} and Ag_{0.9}Sr_{0.1}NbO_{3-δ}. Here, δ is the magnitude of the oxygen vacancy. For maintenance of local electrical neutrality, replacement of a Ag⁺ ion with either of Mg²⁺, Ca²⁺, or Sr²⁺, should lead to removal of ½O²⁻ from anionic site. Thus, in the case of the three mentioned compounds, the theoretical value of δ is 0.5, in contrast to the theoretical value of δ=0 for the case of AgNbO₃. Since it is known that the surface oxygen and lattice oxygen could play a role in catalyzed oxidation reactions, it was analogously expected that higher levels of oxygen vacancies may influence the antimicrobial activity of the silver substituted AgNbO₃ compounds. Performing AST testing, according to the method of Example 8A, on nanostructured Ag_{0.9}Mg_{0.1}NbO_{3-δ}(C, 90, 120, 0), Ag_{0.9}Ca_{0.1}NbO_{3-δ}(C, 90, 120, 0) and Ag_{0.9}Sr_{0.1}NbO_{3-δ}(C, 90, 120, 0) against. The measured MIC values against Staphylococcus aureus and Pseudomonas aeruginosa didn't show significant difference compared to the case of using nanostructured AgNbO₃(C, 90, 120, 0).

The Role of Mechanical Treatment on the Level of Antimicrobial Activity

In order to illustrate the pronounced effect of mechanical treatments on the antibacterial activity of AgNbO₃ nanostructured aggregates we performed antimicrobial susceptibility test by broth microdilution method according to the procedure of example 8A against Pseudomonas aeruginosa bacterial cells using AgNbO₃(C, 90, 120, 0)and AgNbO₃(C, 0, 0, 0) aggregates. The picture of the microwells is presented in FIG. 6E. As it is observed, the mechanical treatment is indeed the main determinant of the performance in terms of antimicrobial activity. Therefore, in the following we study the effect of each treatment and its duration.

The Effect of High Energy Ball Milling on Antimicrobial Activity

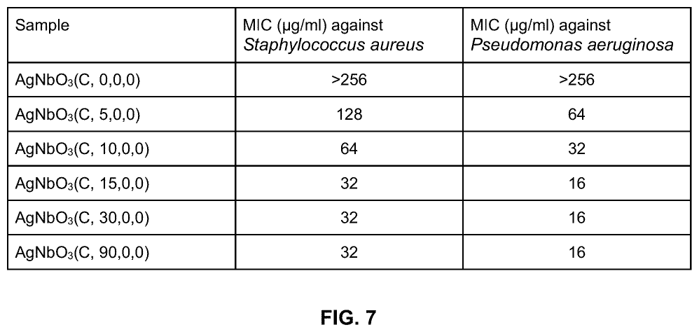

AgNbO₃ was synthesized by the ceramic method following the procedure described in example 1. Then, six alliquotes of the compound were subjected to high energy ball milling for different durations in 0 to 90 minutes range. The resulting samples were subjected neither to low energy ball milling nor to sonication. Then, the antimicrobial activities of the resulting nanostructured aggregates were measured against Staphylococcus aureus and Pseudomonas aeruginosa according to the procedure of example 8A and the results were presented in FIG. 7. As it is observed, subjecting the powder to high energy ball milling treatment with a duration of merely 5 minutes provides it with noticeable antimicrobial action. We have determined that this treatment increases the specific surface area of the compound to above 1 m²/g. Thus, we take this specific surface area as a proxy for the onset of the antimicrobial activity against representative Gram-positive and Gram-negative bacteria, i.e Staphylococcus aureus ATCC 29213 and Pseudomonas aeruginosa ATCC, respectively.

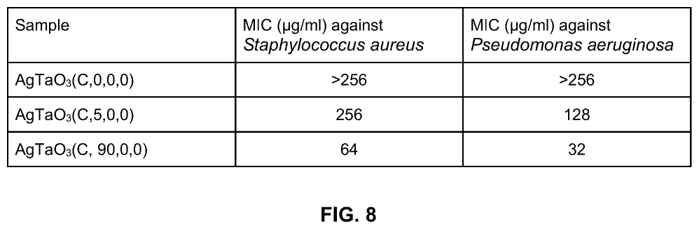

The experiment was repeated for AgTaO₃ ceramic and the result was presented in FIG. 8. The similarity of the MIC values for the case of two compounds, i.e. AgNbO₃ and AgTaO₃, indicates that silver is the main agent of the antimicrobial activity.

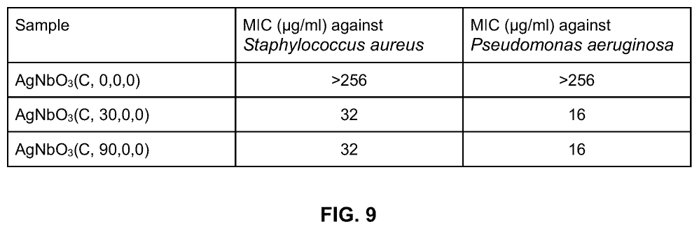

The high energy ball milling, as described in example 3, is performed by balls made of hardened steel. Hard balls may also be made by other hard materials such as zirconium oxide, alumina, tungsten carbide, etc. Employing hardened steel balls is associated with the potential issue of contamination of nanoparticles with iron. We have indeed observed the appearance of Fe 2p peaks in 700-750 eV on the XPS spectrum of AgNbO₃ after performing high energy ball milling by hardened steel balls. However, this does not have a detrimental effect on the antimicrobial activity of the compound as evidenced by the following experimental observations: AgNbO₃ was synthesized by ceramic method according to the procedures of example 1. The high energy ball milling by two different durations of 30 and 90 minutes were performed using crucible and ball made of Tungsten carbide. The antimicrobial susceptibility test via broth microdilution method was performed according to the method of example 8A. The measured MIC values are presented in FIG. 9.

The high energy ball milling process can be replaced by other means such as exposing the ceramic to high energy laser pulses. In one embodiment, the crystal is exposed to a train of short laser pulses with sub-nanosecond pulse durations and photon energies less than the bandgap energy of the ceramic. In this case, the laser beam can create filaments inside the ceramic and the resulting matter-photon interaction in the filament region can impart enormous mechanical stresses sufficient for locally fracturing the ceramic.

The Effect Of Low Energy Ball Milling On Antimicrobial Activity

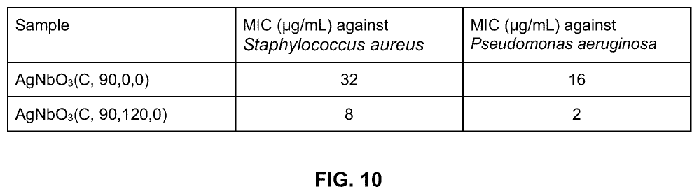

AgNbO₃ were synthesized following the ceramic method following the procedure described in example 1. The compound was subjected to high energy ball milling for a duration of 90 minutes according to the procedure of example 3. Aliquots of the resulting material were subjected to different durations of low energy ball milling according to the procedures of example 4. Then, the antimicrobial activities of the resulting nanostructured aggregates were measured against Staphylococcus aureus and Pseudomonas aeruginosa according to the procedure of example 8A. The measured MIC values are presented in FIG. 10. As it is observed, low energy ball milling enhances the antimicrobial activity by 4 folds.

We have noticed that the beneficial effect of low energy ball milling on the antimicrobial activity starts from processing duration of as short as 10 minutes and reaches a plateau after processing duration of about 90 minutes. Thus, depending on the desired level of the antimicrobial activity, low energy ball milling duration can be selected in the range of 10 to 120 minutes. If a continuous ball milling process is employed, the residential time of the material in the mill is considered as the duration of milling process.

The low energy ball milling is an optional process for enhancing the antimicrobial activity when the compound is synthesized employing the ceramic method of Example 1. However, we have observed that in the case of AgNbO₃ synthesized following the sol-gel method of Example 2, it mitigates the issues arising from the rapid settling of untreated samples in the aqueous media. This drawback can also be mitigated by subjecting the product to sonication as will be described below.

The Effect of Sonication on Antimicrobial Activity

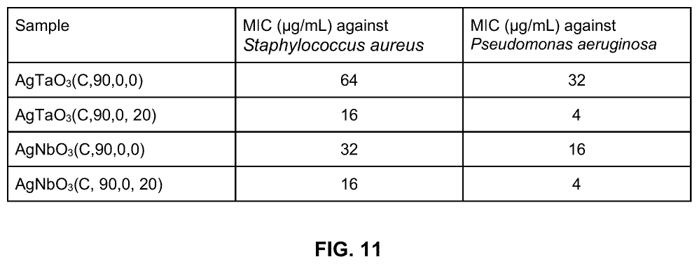

AgNbO₃ and AgTaO₃ ceramics were synthesized following the ceramic method following the procedure described in example 1. The compound was subjected to high energy ball milling for a duration of 90 minutes according to the procedure of example 3. Aliquots of the resulting material were subjected to different durations of sonication according to the procedures of example 5. Then, the antimicrobial activities of the resulting nanostructured aggregates were measured against Staphylococcus aureus and Pseudomonas aeruginosa according to the procedure of example 8A. The measured MIC values are presented in FIG. 11. As it is observed, sonication enhances the antimicrobial activity by 2-8 folds. Still, sonication is not as effective as low energy ball milling for enhancing the antimicrobial activity.

Using Antimicrobial Nanostructured Silver Perovskite Oxide For Biofilm Prevention

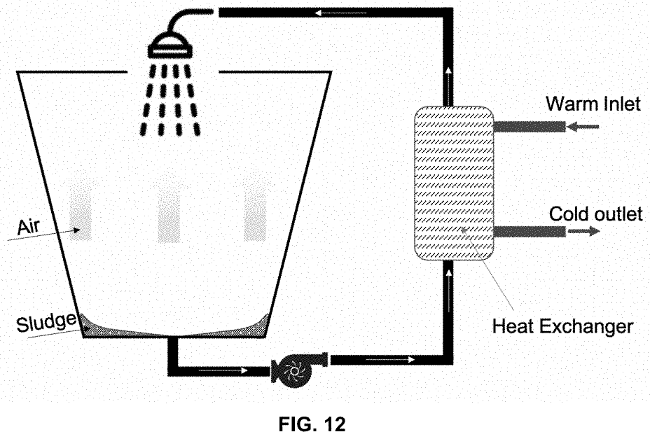

The nanostructured nanostructured silver perovskite oxide may be used for protecting cooling towers, particularly open recirculating types, which are schematically represented in FIG. 12, from issues arising from a variety of microorganisms and microbiological growth. Microorganisms enter the cooling tower either through the make-up water or from the atmosphere. In order to prevent their proliferation, the water should be systematically disinfected using chemicals and must be cleaned at least twice a year. It is recommended that the applied antimicrobials be varied by altering oxidizing and non-oxidizing antimicrobial agents. Along with microorganisms, some solid particles also enter cooling water (i.e. dirt, dust, etc.) and slowly settle down in the regions where the water is stagnant, thus forming sludge. The sludge provides a perfect environment for proliferation of the microorganisms, including bacteria, fungi, algae and cyanobacteria, due to its ideal temperature and the relative protection that it offers to the microorganisms against disinfectants. The escape of some bacterial species, in particular Legionella pneumonia, via the drift eliminator in the vicinity of hospitals is a health hazard.

The broad-spectrum antimicrobial activity of the nanostructured nanostructured silver perovskite oxide of the present disclosure is an advantage as the laborious step of selecting an effective antimicrobial according to the identity of the causative microbial species is not required.

The nanostructured silver perovskite oxide can be intermittently provided to the feed through water. These will gradually settle by the gravitational force on the surfaces, especially where the water is stagnant, and become part of the sludge, thus preventing any microbial growth in the dead zones without requiring new doses as the nanoparticles retain their antimicrobial action. Preventing the proliferation of the microorganisms in the cooling water and within the sludge will considerably reduce the application of chemicals, usually environmentally hazardous, and the frequency of tower cleaning.

The concentration of the nanostructured silver perovskite oxide added to the water should be such that after settling to the proximity of the reservoir surfaces its concentration in the sludge exceeds the amount necessary for preventing the proliferation of different organisms. In one embodiment the concentration in the sludge is selected to be at least 10 times of the measured MIC values against the reference Pseudomonas aeruginosa ATCC 27853 bacterial cells. In another embodiment the concentration in the sludge is selected to be at least 5 times of the measured MIC values against the reference Pseudomonas aeruginosa ATCC 27853 bacterial cells.

Incorporating Antimicrobial Particles On Surfaces

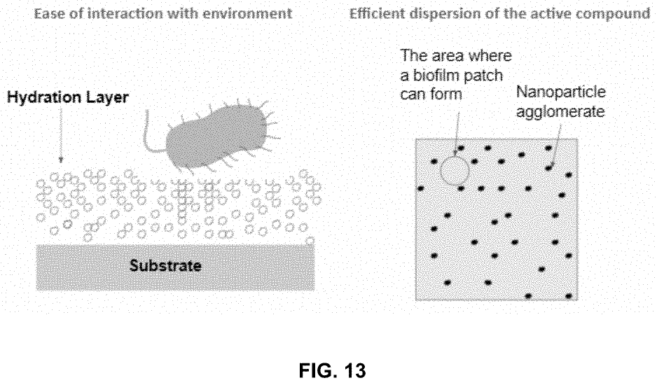

One objective of the present invention is tightly embedding nanoparticles on a surface without compromising their ability to come into contact with microbial cells. The potential application of antimicrobial surfaces includes hospital interiors requiring high levels of sterility, coatings of devices implanted in the body, and the tubings for bodily fluids such as catheters. Recently, some promising approaches have been investigated for engineering the silver hydrogel matrix and hydrogel impregnated with silver nanoparticles. Noting that these approaches still face the issues related to the health and environmental hazards associated with silver ion release, ceramic nanoparticle agglomerates can be an appropriate alternative to the corrosion susceptible silver nanoparticles. Apart from the requirements related to tight incorporation of particles on a surface while avoiding the possible shielding of the nanoparticles, the hydrophobicity of the resulting surface should also be adjusted to facilitate the interaction of microbial cells with the exposed nanoparticles as presented in FIG. 13. Therefore, one objective of the present invention is embedding the nanoparticles on the surface without covering them.

Another parameter for preparation of the antimicrobial surface is the density of exposed nanostructured aggregates to prevent the formation of microscale biofilm patches. We have empirically determined that the surface coverage of the nanostructured aggregates is preferably over 1%.

Tightly embedding nanoparticles on the target surfaces is important in two respects; requirements for durability, and minimizing health hazard. One parameter which should be taken into account in preparing an antimicrobial surface, is the preference for the hydrophilicity of the finished surface. However, the surface is not required to have intrinsic hydrophilicity and this property can be supplied to the surface after embedding the nanoparticles. Among known approaches for achieving this are plasma treatment for incorporation of new polar functional species on the surface.

Incorporation of nanoparticles in a matrix, such that the antimicrobial nanoparticles located at the surface are left exposed at an appropriate surface density, is one aspect of the present invention. In one embodiment, we incorporate the antimicrobial nanoparticles into the polyester polymer matrix via the method of example 11. Alternatively, the antimicrobial nanoparticles were embedded in a glass matrix according to the method of example 12. The antimicrobial properties of the resulting surfaces were illustrated following the method of example 10.

The resulting antimicrobial resin can be used as a binder in manufacturing composite materials such as quartz countertops. The resulting antimicrobial resin can also be applied on solid surfaces as an antimicrobial coating. One intended application of the antimicrobial nanoparticle embedded composite materials are engineered stones, which are the solids made of ceramic aggregates and a binder, followed by forming, curing and polishing steps. One of well-known engineered stones is the Quartz countertop. The manufacturing process of the Quartz countertop consists of mixing quartz particles with different size distributions and polyester or epoxy resin, followed by forming and curing processes. The size distribution is obtained by sieving the quartz feedstock in different sizes; i.e. >1 mm, 0.5-1 mm, 0.1-0.5 mm, <0.1 mm. The smallest fraction is called fine fraction.

In one embodiment, the antimicrobial nanostructured aggregates are mixed with the finest fraction of quartz particles. The mixing is performed either in an attrition mill or a high-energy ball mill for 2 h. Then, the finest fraction is blended with the large fractions, while adding the binder (and color pigments). The mass fraction of the binder is between 4 and 10%. The blended mixture is then molded in the form of a thick slab and compacted under a pressure of 20-60 MPa. The final thickness of the sample is about 2.54 cm (1 inch). Alternatively, the molded sample can also be vibro-compacted under a pressure of 1-2 MPa. The compacted slab is put in an oven (50-90° C.) and cured for a period of time ranging between 4 h and 10 h, followed by a slow cooling to room temperature.

In another embodiment, the engineered quartz is made by mixing the quartz aggregates and the antimicrobial resin (as described above). The overall structure of the engineered quartz is schematically presented in FIG. 16.

### EXAMPLES

### Example 1: Synthesis Of AgMO₃ (M=Nb or Ta) Compound with Ceramic Method

The ceramic method comprises direct reaction between stoichiometrically appropriate amounts of corresponding oxides which are finely powdered, thoroughly mixed, and heated to elevated temperatures. In the case of AgNbO₃, the raw materials Ag₂O (Sigma-Aldrich Corp) and Nb₂O₅ (Inframat® Advanced Materials LLC) were calculated at 1000° C. for 4 h in O₂ atmosphere. The reduction of Ag₂O to metallic silver occurs first, followed by a simultaneous reaction of three species (O₂, Ag, and Nb₂O₅) to form the perovskite phase. The molecular oxygen, which evolves during the initial decomposition of Ag₂O, diffuses into the Nb₂O₅ bulk. The reaction temperature was selected as the following. The overall chemical reaction is Ag₂O+Nb₂O₅ →AgNbO₃. Since the molar masses of Ag₂O and Nb₂O₅ are respectively 231.735 g/mol and 265.81g/mol, for every g of Ag₂O, 1.147 g of Nb₂O₅ powders are mixed in a hardened steel crucible with high energy ball milling for 10 minutes. The mixture is transferred to a ceramic crucible and placed in an oven where it is gradually heated at a rate of 5° C./min until the formation temperature, T_{f}, is reached. The mixture is kept at this temperature for about 4 hours and gradually cooled down at a rate of 10° C./min to room temperature.

The ceramic can also be prepared such that the resulting compound has the general formula AgₓM₁₋ₓNb_{y}Z_{1-y},O₃, where M is another metal such as Mg, Ca or Sr, and Z is another transition metal such as Ta, Co, Sb, etc. For this purpose, oxides of the target metal with stoichiometric amounts are mixed with the raw material at the first step.

### Example 2: Synthesis of AgMO₃ Compound With Sol-Gel Method

A mixture of 0.01 mol, 4.47 g of Niobium ammonium oxalate (C₄H₄NNbO₉.xH₂O, Sigma-Aldrich Corp), 0.01 mol, 1.69 g silver nitrate (AgNO₃, Fisher Scientific International, Inc) and 8.40 g Citrate acid (C₆H₈O₇, Fisher Scientific International, Inc) were dissolved in 30 mL Hydrogen peroxide (H₂O₂, Fisher Scientific International, Inc). After adding 2 mL Nitric acid (HNO₃, Anachemia Canada, Inc), the mixture was kept at 65° C. for 1 h to decompose oxalate within niobium ammonium oxalate. Then, the pH value of the solution was adjusted to about 6.5 by dropping Ammonia (NH₃, VWR International, LLC) to obtain a yellowish solution. The precursor solution turned into a resin-like gel with a high viscosity by heating at 120° C. for several hours. The gel was treated at 300° C. for 2 h to burn out unnecessary organics, and then calcined at 550° C. for 2 h. The examination by XRD confirmed the formation of perovskite crystalline structure.

### Example 3: Powder Treatment by High Energy Ball Milling

The milling process was carried out using the 8000D Mixer/Mille (SPEX SamplePrep, LLC) in which 7 g of material was agitated at 1060 cycles per minute for durations of up to 90 minutes. The apparatus system also contains a supporting crucible and typically three milling balls. The crucible chosen was the 8001 hardened steel vial set, which contains a vial size of 2¼ n. Dia.×3 in, the vial body and cap liner being made of hardened tool steel. Two ½ in. and one ¼ in. steel balls were used for grinding. The high energy ball milling process reduces crystallite size down to nanometer scale. This statement is supported by the observation that following post synthesis treatment by high energy ball milling the XRD peaks are significantly broadened. The resulting material is typically in powder form with hard agglomerates of the nanoscale crystallites that have sizes of order of few micrometres.

Alternatively, the milling process is performed by a horizontal high energy attritor (e.g., type ZOZ Simoloyer).

### Example 4: Powder Treatment by Low Energy Ball Milling

Subjecting powders to a low energy attrition mill applies a shear stress on the agglomerates resulting in the separation of nano crystallites, thus increasing specific surface area beyond 2 m²/g. In this step, approximately 40 g of powder from the previous step (agglomerates) was added to a crucible containing hundreds of steel beads of 4.5 mm in diameter, which were made to rotate at 90 rpm by Szegvari Attritor System Type E Model 01-STD (Union Process, Inc.). To this, 10 mL of water (or alcohols such as ethanol) was added and the attrition process was performed for a selected time duration. At the end of the operation the beads are rinsed with deionized water and the residue thus obtained was dried inside an oven with a temperature of 150° C. for overnight.

### Example 5: Powder Treatment by Sonication

Subjecting powders to a sonication applies a shear stress on the agglomerates resulting in the separation of nano crystallites, thus increasing specific surface area. In this step, approximately 0.5 g of powder from the previous step (agglomerates) was suspended in 100 mL water in a 250 mL beaker and was subjected to sonication with 60 W by a Sonic dismembrator model FB705 (Fisher Scientific International, Inc.) for selected time duration. At the end of the operation the beads are rinsed with deionized water and the residue thus obtained was dried inside an oven with a temperature of 150° C. for overnight.

### Example 6: Measuring Specific Surface Area

The specific surface area was measured with a TriStar II 3020 (Micrometrics Instruments Corp) instrument as the following: 250 mg of nanoparticles was degassed at 300° C. for an overnight time period. Then, the input parameters on the software were selected as:

1. Surface area and pore size powder for analysis condition

2. Adsorptive gas: Nitrogen at 77.35 K

3. The measurement was reported for N₂ gas The instrument's software TriStar II 3020 Version 3.02 performed statistical analysis and reported specific surface area in m²/g units.

### Example 7: Measuring the Morphology and Size Distribution

The size and morphology of nanostructured aggregates was studied with Dynamic Light Scattering (DLS) and Transmission Electron Microscopy (TEM) as described below.

A 0.01 mg/mL nanostructured aggregate was prepared in nano pure water and was subject to 10-minute ultrasound (Fisher Scientific FS530H) and subsequent 1-minute vortex (VWR Analog vortex mixer) for homogenous particle distribution. Prior to sending the sample for Transmission Electron Microscopy (TEM) analysis a measure of the size distribution of the particle is made, using Dynamic Light Scattering (DLS) technique. A 40 μL aliquot of the sample is added to the DLS sample holder (ZEN0040 disposable microcuvette) and the 3 replicates per sample DLS measurements are performed by Malvern ZEN1600 DLS machine, with the following parameters specified: Nanoparticle refractive index of 1.96, Temperature of 25° C., and Equilibrium for 2 minutes. After DLS analysis, 5 microliters of each suspension were added onto a TEM grid, the volume of which was deemed the optimal amount for obtaining a monolayer of nanoparticles in a TEM image. The TEM grids used were 300 mesh and made of copper, containing a carbon film (Electron microscopy Sciences, Pennsylvania, USA). The sample was given 1 minute to settle. A paper filter was used to remove extra liquid from the sample. The sample was given a few days to dry as much as possible. The size and morphology of the particles were inspected using the JEM-1230 electron microscope from JEOL, Ltd (Japan Electron Optics Laboratory). The voltage used for the experiments was set at 80 KV. Images of the nanoparticles representative of the overall view with magnifications of 1000×, 5000×, 20000×, 60000×, 100000× were taken for each sample.

### Example 8A: Measuring Antimicrobial Activity by Broth Dilution Method

The broth microdilution antimicrobial susceptibility test (AST) involves growing bacterial cells inside a series of wells on a microwell plate containing growth media. Each well is supplied with different concentrations of the antimicrobial agent, differing by a factor of two from one well to the next. Known number of bacterial cells in the range of 10⁵ CFU (CFU=colony forming unit, meaning a cell that is viable and can divide) is dispensed into each well. After overnight incubation, the wells are inspected for signs of growth by visual inspection or turbidimetry. Thus, the minimum concentration required to inhibit growth is determined and reported as minimum inhibitory concentration (MIC) value. The MIC is defined as the lowest concentration of an antibiotic that will inhibit the visible growth of an organism after overnight incubation

### Example 8B: Assessing the Development of Resistance to Antimicrobial Activity

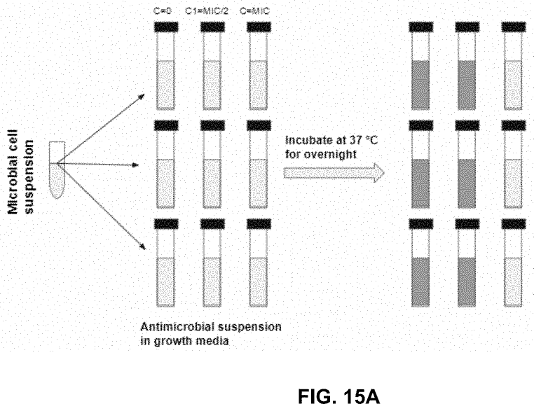

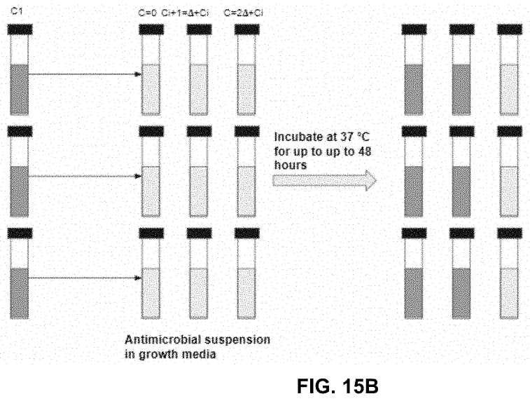

The experimental procedure for verifying this speculation is described by referring to FIGS. 15A and 15B. The experiment starts with determination of MIC value employing the broth dilution method, as described in Example 8C. Then 10 mL of antimicrobial suspensions with concentrations of 0, c₁=MIC/2, and MIC are prepared in growth media each in three replicas. In each tube 20 μL of microbial cell suspension with concentration of 0.5 M is spiked and the tubes are incubated overnight at 37° C. It is expected that the cells will grow at tubes containing the antimicrobial agent at concentrations 0 and c₁=MIC/2, and there will be no growth at c=MIC. In the next stage 10 mL of antimicrobial suspensions with concentrations of 0, c₂=Δ+c₁=, and c=2Δ+c₁ are prepared in growth media each in three replicas, where Δ is a fraction of MIC.

In each tube 20 μL of microbial cell suspension from the content of the tube with concentration of c1 is spiked and the tubes are incubated at 37° C. for up to 48 hours until the growth is observed in tubes with c=0 and c=c_{2.} The procedure is repeated for i+1 (i =2, 3, . . . ) times until no growth is observed at all tubes with concentration cᵢ+1=iΔ+MIC/2.

### Example 9: Measuring Antimicrobial Activity by Agar Dilution Method

In order to measure the MIC values by Agar dilution method, agarose petri dishes with different concentrations of antimicrobial agents, differing by a factor of 2, are prepared as follows. In another tube an antimicrobial solution (suspension in the case of nanoparticles) with a concentration of 20 times the target concentration is prepared in water. The agarose gel is autoclaved and allowed to cool down in a water bath having a temperature of 50° C. Then 1 mL of the particle suspension is mixed with 19 mL of the gel and is poured into a petri dish and allowed to solidify. Then, following the CLSI guidelines, suspension of target microbial cells is streaked on each petri dish and is incubated overnight. The petri dishes are inspected and the concentration for which the colony growth is inhibited is reported as the MIC value.

### Example 10: Measuring the Antimicrobial Activity of Antimicrobial Surfaces

Antimicrobial activity of a surface is performed by the following steps:

1. Cut small discs with a diameter of 1 cm from the surface.

2. Sterilizing the disks by soaking them in alcohol for 2 hours.

3. Air dry the disks.

4. Dispense a bacterial suspension on the disk to cover its surface.

5. Air dry the disks overnight.

6. Place the disks in tubes containing liquid culture medium.

7. Incubate the tubes at 35 degrees overnight.

8. Visually inspect the tubes for turbidity (bacterial growth).

9. Subculture from liquid culture medium on solid agar medium to verify that there was no bacterial growth in liquid medium.

### Example 11: Synthesizing Antimicrobial Sample with Resin Matrix

50 mg of AgNbO₃(C, 90, 120, 0) was added to a solution containing 5 mL acetone and 5 mL polyester resin (Castin'Craft Resin; Environmental Technology, Inc.) and the solution was vortexed. Then the solution was added to 90 mL of Castin'Craft Resin and 10 mL of acetone and was subjected to low energy ball milling to disperse the nanostructured antimicrobial within the resin, as described in example 4 above, for 30 minutes. Alternatively, the depression process could be done by sonication. This mixture was designated as a sample with a concentration of 500 mg/L. Aliquots of this sample were diluted by factors of 10 folds to obtain concentrations of 50 and 5 mg/L, respectively. The solutions, designated as antimicrobial resin, were poured onto drain filters positioned on top of a cup to remove milling balls. 30 drops of Castin'Craft hardener catalyst (Environmental Technology, Inc.) were added to this collected liquid, which was then poured onto a casting mold and allowed 1 day to solidify.

The foretold antimicrobial resin can also be applied as an antimicrobial coating on solid surfaces.

### Example 12: Synthesizing Solid Samples with Glass Matrix

For this form of solid surface synthesis, pieces of glass were crushed to powder form by subjecting it to high energy ball milling as outlined in example 3 for 15 minutes. This was repeated until 40 g of the powder form of this glass was obtained. Of this powder glass, 6.3 g was taken and mixed with 0.7 mg of AgNbO₃(C, 90, 120, 0) nanoparticle by high energy ball milling as outlined in example 3, for 1.5 hours. This was designated as the stock containing ₁₀% AgNbO₃(C, 90, 120, 0) nanoparticles. Dilution by factors of 10× and 100× were performed by mixing 0.7 g of the previously synthesized stock with 6.3 g of glass powder and subjecting the mixture to high energy ball milling, as outlined in example 3, for 1.5 hours. Finally, the 10%, 1% and 0.1% stocks were mixed with Polypropylene wax powder (Ceridust) with a weight ratio of Ceridust: glass of 9:1 and were compressed to form solid antimicrobial pellets.

1. An antimicrobial silver perovskite oxide, wherein the antimicrobial silver perovskite oxide has a specific surface area of at least 1 m²/g.

2. The method according to claim 1, where and a silver release rate of less than 0. 1% of its weight over 24 hours into deionized water at room temperature.

3. The method according to claim 1, where antimicrobial silver perovskite oxide is selected from the group consisting of at least one of the group AgNbO₃ and AgNbO₃.

4. A method of preparing the antimicrobial silver perovskite oxide of claim 1 comprising:
mixing the Ag₂O powder with appropriate amounts of either Nb₂O₅ or Ta₂O₅;
heating the mixture to a formation temperature in the range of 800° C. and 1100° C.;
maintaining the mixture at the formation temperature for at least 30 minutes;
cooling down the product to ambient temperature to obtain a polycrystalline solid;
subjecting the polycrystalline solid to high energy ball milling to obtain a nanostructured silver perovskite oxide.

5. The method according to claim 4, where the high energy ball milling is performed for a duration of at least 5 minutes.

6. The method according to claims 4 where the nanostructured silver perovskite oxide is subjected to further treatment by subjecting it to low energy ball milling for a duration of at least 10 minutes.

7. The method according to claim 6 where the low energy ball mill is performed in an attrition mill using a media of beads of diameters ranging between 1 mm and 5 mm.

8. The method according to claim 6 where the milling media comprises at least one of ceramic beads, metallic beads and quartz beads.

9. The method according to claim 6 where the treatment by low energy ball milling is performed until the specific surface area of the nanostructured silver perovskite oxide exceeds 2 m²/g.

10. The method according to claim 6 where the treatment by low energy ball milling is performed by adding water into the milling media.

11. The method according to claim 6 where the treatment by low energy ball milling is performed by adding alcohol into the milling media.

12. A method of prevention of microbial proliferation in a cooling tower by adding antimicrobial silver perovskite oxide of claims 1 to the water reservoir of the cooling tower.

13. The method according to claim 12 where the amount of the antimicrobial silver perovskite oxide added to the water is selected such that its concentration in a sludge within the water reservoir is at least 10 times higher than the minimum inhibitory concentration against Pseudomonas aeruginosa ATCC 27853.

14. The method according to claim 10 where the amount of the antimicrobial silver perovskite oxide added to the water is selected such that its concentration in the sludge is at least 5 times higher than the minimum inhibitory concentration against Pseudomonas aeruginosa ATCC 27853.

15. A method of preparing an antimicrobial surface, the method comprising:
dispersing the antimicrobial silver perovskite oxide of claim 1 within a matrix;
mixing the dispersion with a binder; and
treating the mixture to form a solid with an antibacterial surface.

16. The method according to claim 15, where the matrix is glass powder with a w/w ratio of at most 99/1 relative to the antimicrobial silver perovskite oxide.

17. The method according to claim 15, where the matrix is a polymer with a w/w ratio of at most 99/1 relative to the antimicrobial silver perovskite oxide.

18. The method according to claim 15 where the dispersing process is performed using a ball mill.

19. The method according to claim 15 where the dispersing process is performed in an attrition mill.

20. The method according to claim 15, where the dispersed nanostructured mixed oxide is coated on a solid substrate to form an antimicrobial surface.
